(19) United States
(12) Patent Application Publication
(10) Pub. No.: US 2024/0233192 A1
(43) Pub. Date: Jul. 11, 2024

(54) Adaptive Region-based Resolution for Dynamic Mesh Coding

(71) Applicant: Ofinno, LLC, Reston, VA (US)

(72) Inventor: Chao Cao, Reston, VA (US)

(73) Assignee: Ofinno, LLC, Reston, VA (US)

(21) Appl. No.: 18/406,927

(22) Filed: Jan. 8, 2024

Related U.S. Application Data
(60) Provisional application No. 63/437,584, filed on Jan. 6, 2023.

(51) Int. Cl. G06T 9/00; G06T 17/20

(52) U.S. Cl. CPC G06T 9/001; G06T 17/205

(57) ABSTRACT

A decoder receives, from a bitstream, subdivision information indicating sub-volumes of a volume containing a base mesh of a mesh. Each sub-volume of the sub-volumes indicates a respective base sub-mesh of base sub-meshes together forming the base mesh. The base mesh is subdivided according to the subdivision information with each base sub-mesh of the base sub-meshes being subdivided based on a subdivision parameter corresponding to the sub-volume indicating the base sub-mesh. The mesh is generated based on the subdivided base mesh.

### CROSS-REFERENCE TO RELATED APPLICATIONS

This application claims the benefit of U.S. Provisional Application No. 63/437,584, filed Jan. 6, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8 illustrates an example of applying adaptive subdivision to a base mesh (e.g., a reconstructed base mesh) to generate a subdivided mesh, according to some embodiments.

FIG. 9 illustrates an example of subdivision information indicating adaptive subdivision of a base mesh, according to some embodiments.

FIG. 10 illustrates an example for determining whether a triangle is in a cuboid (or a sub-volume), according to some embodiments.

FIG. 11 illustrates an example of determining subdivision parameters adaptively, according to some embodiments.

FIG. 12 illustrates an example of metadata to be transmitted for the input mesh (e.g., mesh frame), according to some embodiments.

FIG. 13 illustrates a flowchart of an example method for encoding an input mesh (e.g., an input mesh frame or the reconstructed base mesh), according to some embodiments.

FIG. 14 illustrates a flowchart of an example method for encoding an input mesh, according to some embodiments.

FIG. 15 illustrates a flowchart of an example method for decoding a mesh to generate a reconstructed mesh corresponding to an input mesh, according to some embodiments.

FIG. 16 illustrates a flowchart of an example method for decoding an input mesh, according to some embodiments.

FIG. 17 illustrates an example encoder for encoding attributes information of 3D mesh frames, according to some embodiments.

FIG. 18 illustrates an example of patch projection, according to some embodiments.

FIG. 19 illustrates an example of patch packing, according to some embodiments.

FIG. 20 illustrates an example of patch packing, according to some embodiments.

FIG. 21 illustrates an example decoder for decoding attribute information of 3D mesh frames, according to some embodiments.

FIG. 22 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of points (or pixels) that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may by in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is 3D meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented as vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may by in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

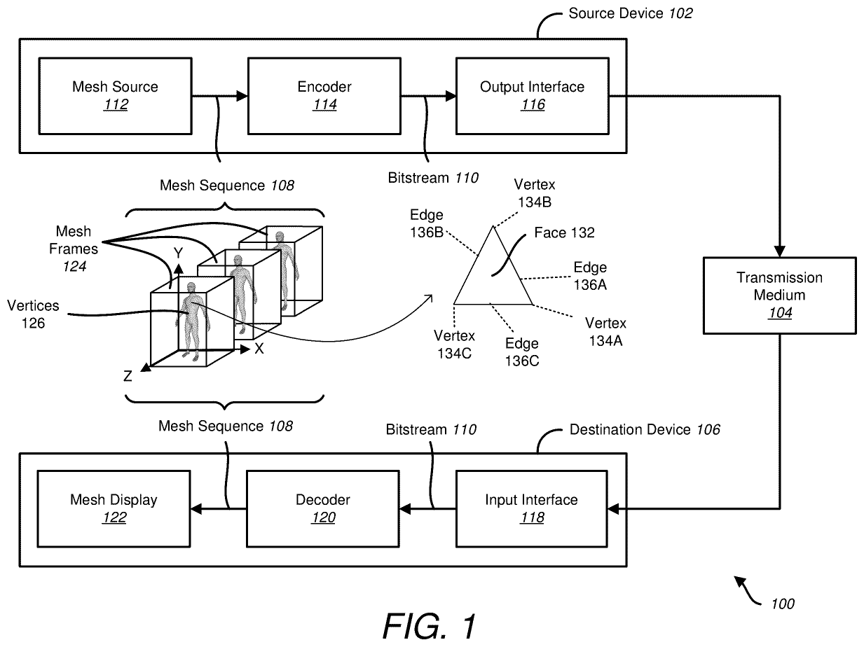

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicated the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex (1/1) is defined as the first geometry coordinate (e.g. 64.062500, 1237.739990, 51.757801), which corresponds with the first texture coordinate (e.g. 0.0897381, 0.740830). A second vertex (2/2) of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

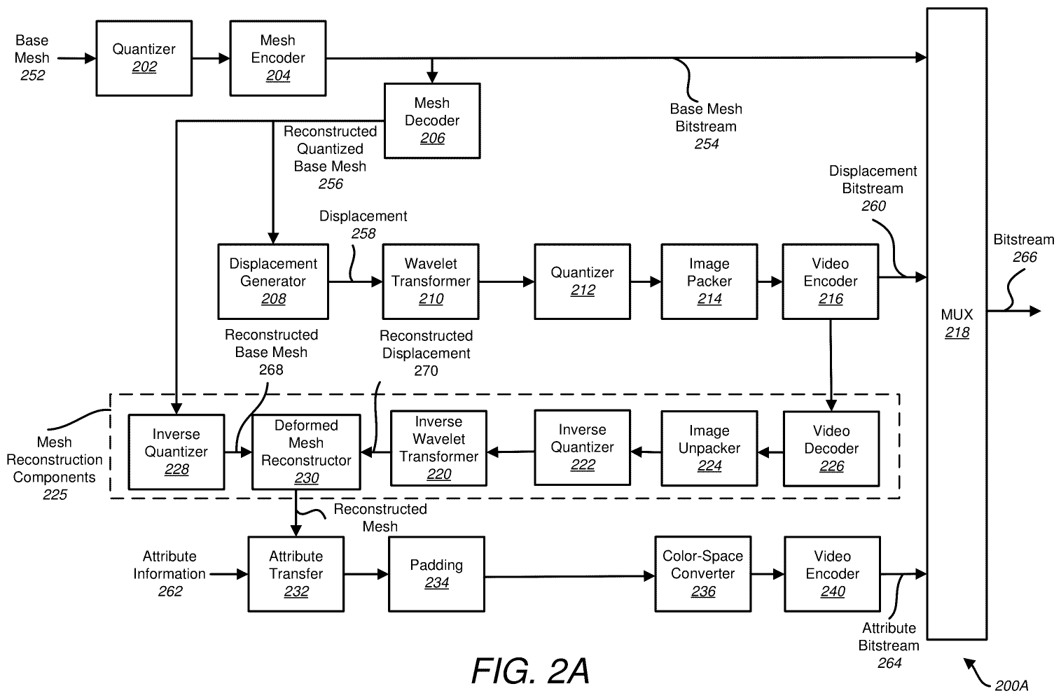

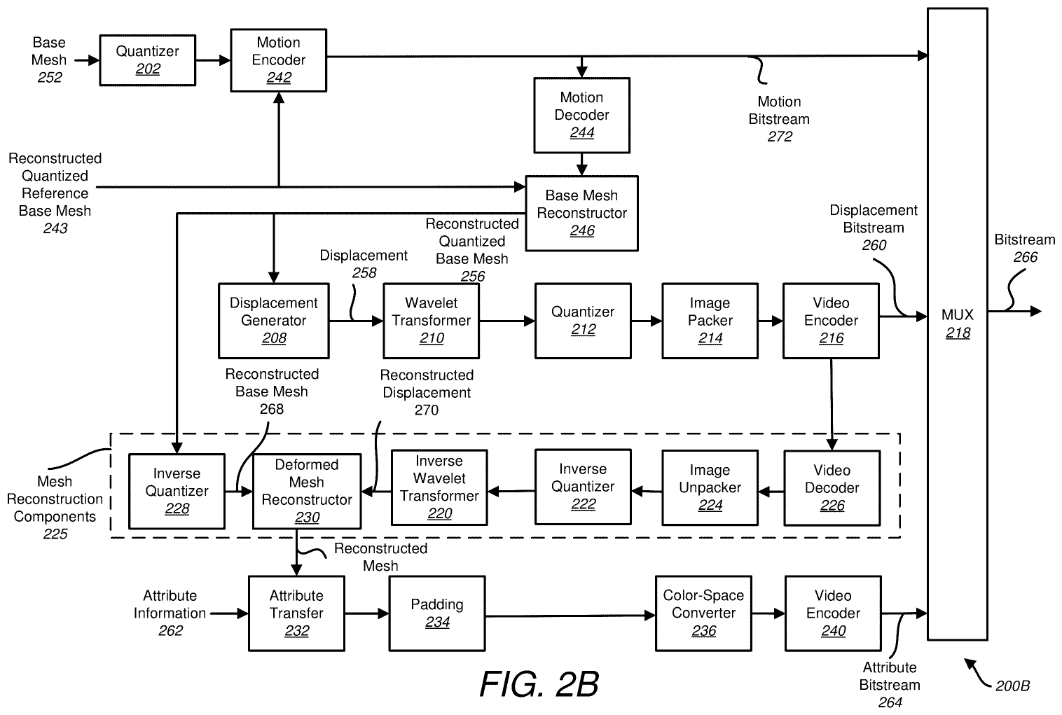

FIG. 2A illustrates a block diagram of an example encoder 200A for intra encoding a 3D mesh, according to some embodiments. For example, an encoder (e.g., encoder 114) may comprise encoder 200A.

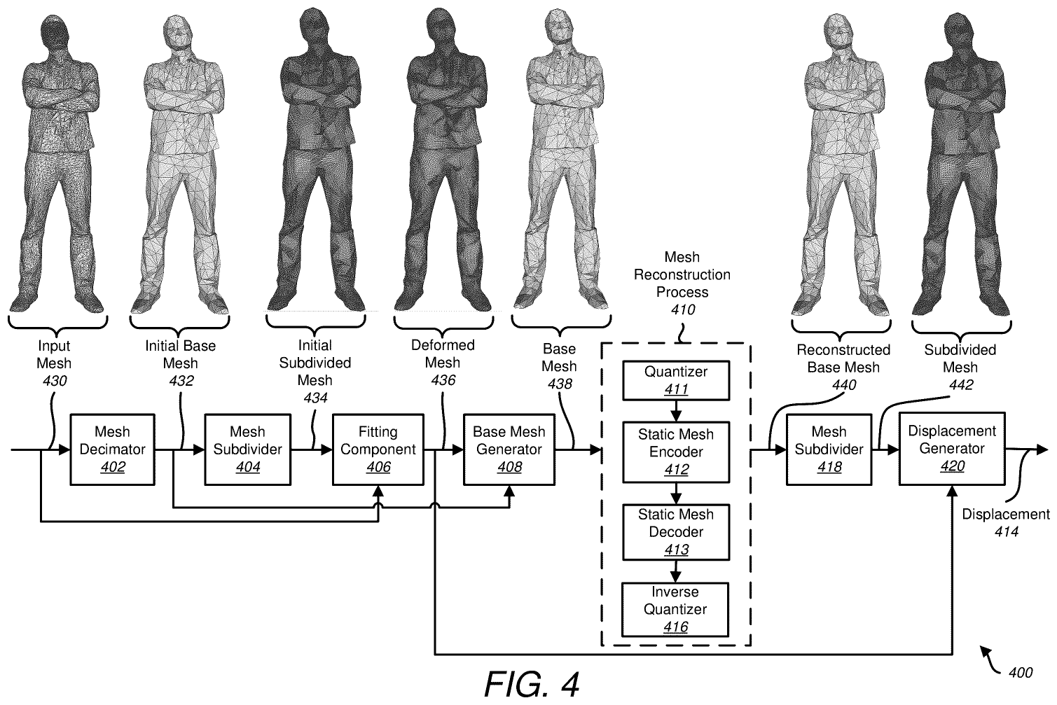

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine to the base mesh (e.g., a decimated mesh or decimated base mesh). A mesh encoder 204 may encode base mesh 252, whose geometry information (e.g., vertices) may quantized by quantizer 202, to generate a base mesh bitstream 254. In some examples, base mesh encoder 204 may be an existing encoder such as Draco or Edgebreaker.

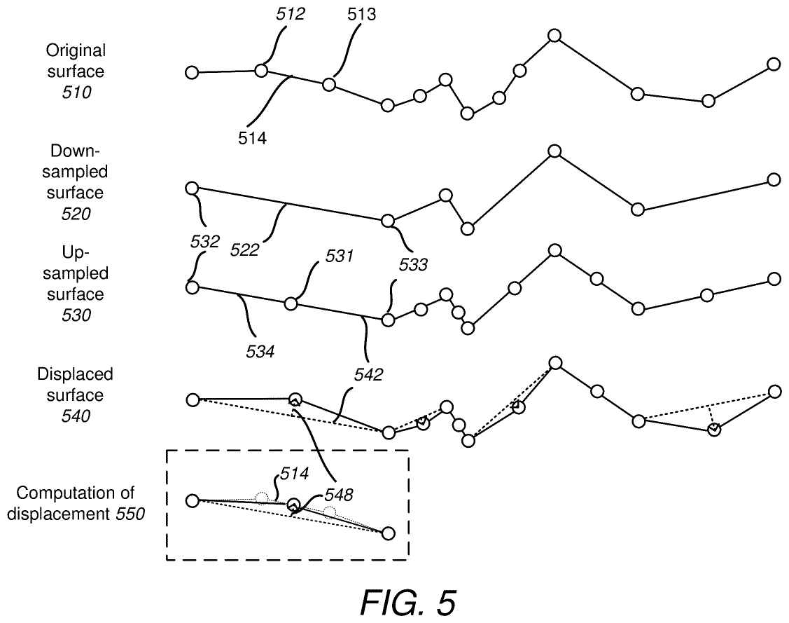

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

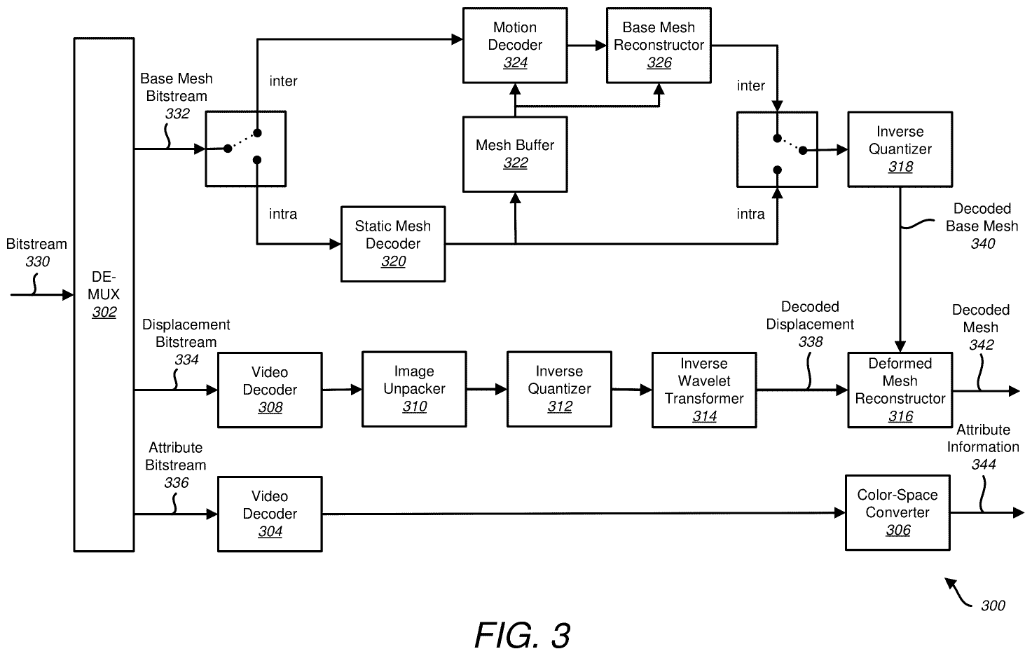

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map or materials information) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., exp-golomb code), a Rice code, or a combination thereof. In some examples, the codeword may be arithmetically coded, e.g., using CABAC. A prefix part of the codeword may be context coded and a suffix part of the coded may be bypass codded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′(j) and applies it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions p(i,v) of the vertex v of m\hat{ }*(i) from the positions Pos(j,v) of the vertex v of m′(j) as follows: f(i,v)=Pos(i,v)−Pos(j,v). The motion field may be further predicted by using the connectivity information of base mesh m′(j) and the prediction residuals may be entropy encoded.

In some examples, since the motion field compression process may be lossy, a reconstructed motion field denoted as f(i) may be computed by applying the motion decoder component. A reconstructed quantized base mesh m′(i) may then be computed by adding the motion field to the positions of vertices in base mesh m′(j). To better exploit temporal correlation in the displacement and attribute map videos, inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430.

Mesh subdivider 404 applies a subdivision scheme to generate initial subdivided mesh 434. Fitting component 406 may fit the initial subdivided mesh to determine a deformed mesh 436 that may more closely approximate the surface of input mesh 430. Base mesh 438 may be output to a mesh reconstruction process 410 to generate a reconstructed base mesh 440. Reconstructed base mesh 440 may be subdivided by mesh subdivided 418 and the subdivided mesh 442 may be input to displacement generator 420 to generate (e.g., determine or output) displacement 414, as further described below in FIG. 5. In some examples, mesh subdivider 418 may apply the same subdivision scheme as that applied by mesh subdivider 404.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. In the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sample surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after decimation process, a higher level of compression can be achieved without significant loss of visual fidelity. Various subdivision schemes may be used such as, e.g., mid-point, Catmull-Clark subdivision, Butterfly subdivision, Loop subdivision, etc.

For example, FIG. 5 illustrates an example of the mid-point subdivision scheme. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center of an edge (v₁, v₂), as follows:

$$Pos ( {v}_{12} ) = \frac{1}{2} ( P o s ( {v}_{1} ) + P o s ( {v}_{2} ) ) ,$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} ,$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh.

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex. In some examples, using the local coordinate system may enable further compression of tangential components of the displacements compared to the normal component.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information.

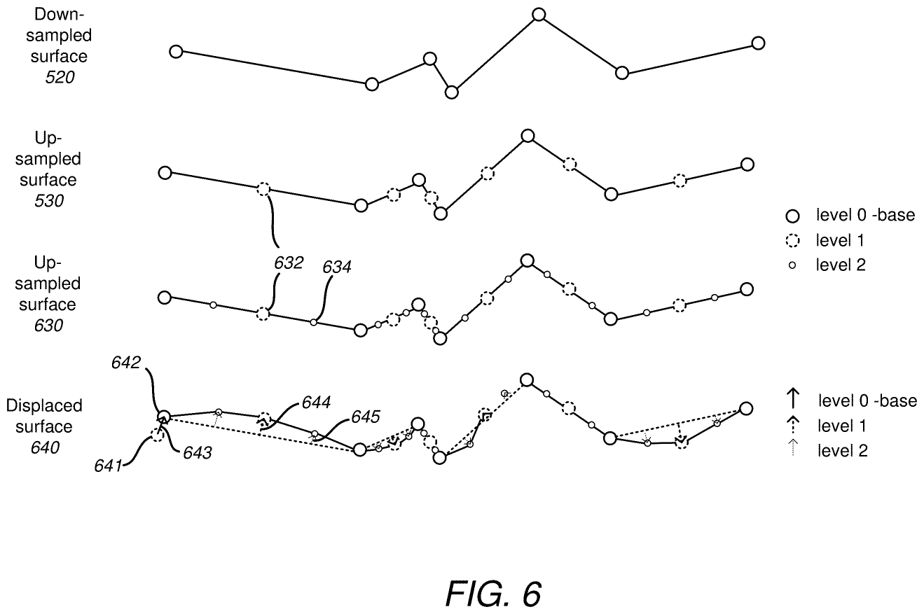

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., LODs). For example, a down-sampled surface 520 (of a decimated mesh) can be subdivided into up-sampled surface 530 after a first iteration of subdivision. Up-sampled surface 530 may be further subdivided into up-sampled surface 630. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520.

In some examples, the computation of displacement in different LODs follows the same mechanism as described above with respect to FIG. 5. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

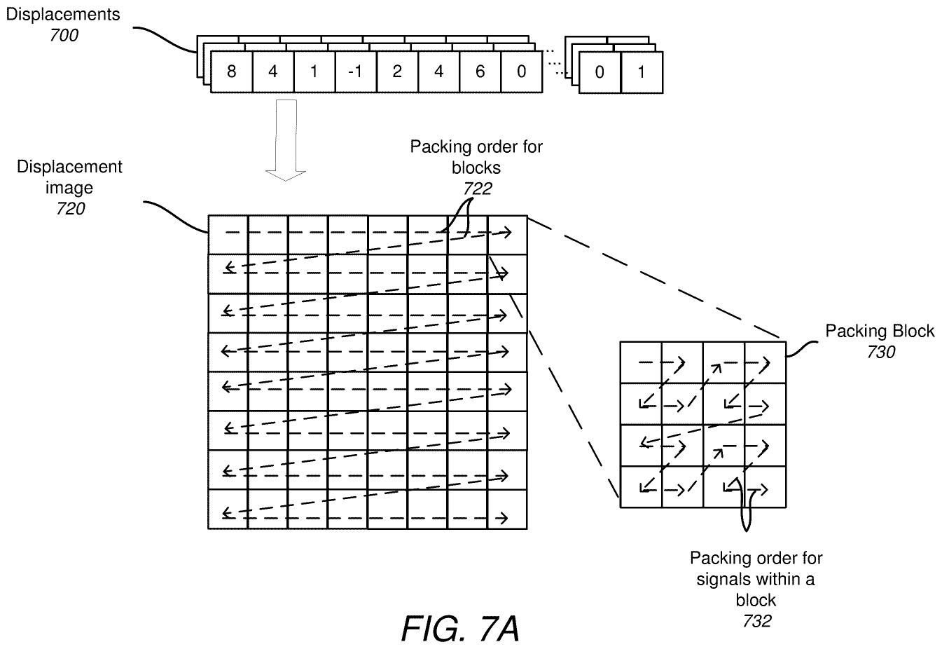

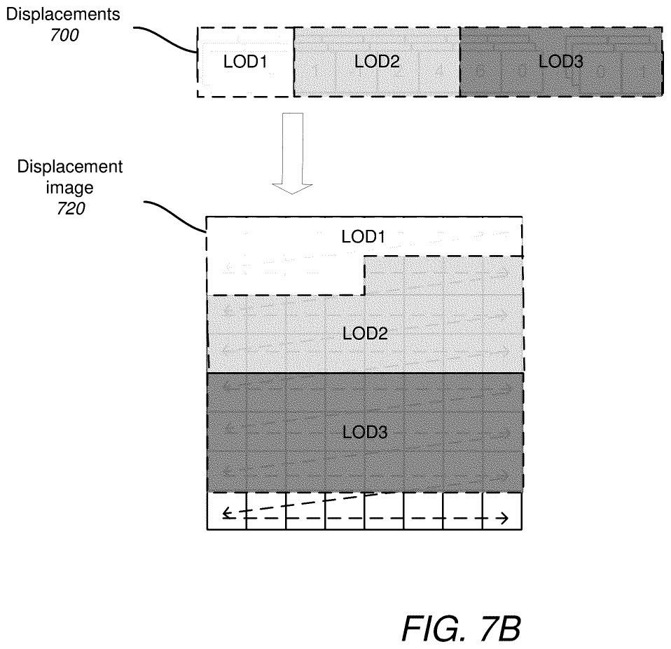

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIG. 5 and FIG. 6, received to be packed into 2D images. In some examples, a displacement can be a 3D vector containing the values for the three components of the distance. For example, a delta x value represents the shift in x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet decomposition process to reconstruct the original displacement values.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to revert the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to corresponding quantization parameters that specify different levels of intensity/precision of the signal to be quantized. For example, wavelet coefficients in LOD 3 may have a quantization parameter with, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

The displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for blocks may be a raster order and a packing order 732 for displacements within packing block 730 may be a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD to a highest LOD. In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, wavelet transform is used to decompose an image (signals) into two discrete components, known as approximations/predictions and details. The decomposed signals are further divided into a high frequency component (details) and a low frequency component (approximations/predictions) by passing through two filters, high and low pass filters. In the example of 2D image, two filtering stages, a horizontal and a vertical filtering are applied to the image signals. A down-sampling step is also required after each filtering stage on the decomposed components to obtain the wavelet coefficients resulting in 4 sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

With the advance in acquisition technologies and the computer rendering capability, 3D content with higher resolution (both spatially and temporally) can now be achieved. Moreover, more 3D content in the form of 3D meshes is appearing. A 3D mesh (e.g., an input mesh) may include various LODs as a representation of different regions of interest (ROIs). The variety of LODs on the 3D mesh (also referred as mesh) is usually captured and reconstructed.

In existing technologies, a 3D mesh object may be compressed with a same level of compression for each mesh frame. To achieve high quality reconstruction, correction information (e.g., referred to as residual or displacement information) may be needed for compensation, as explained above in FIGS. 5-6. Using the same level of compression and sampling everywhere on a single mesh is not optimal and may result in a greater amount of correction data to compensate for the quality of the reconstructed mesh. For example, if a 3D mesh with different resolution levels (e.g., geometry densities of the 3D points) is compressed with a general compression scheme, the level of compression will be the same and some key features can be lost.

For example, an input mesh frame may be encoded by generating a base mesh (e.g., a reconstructed base mesh) for the input mesh and generating a subdivided mesh from the base mesh, as explained with respect to FIGS. 4-6. A subdivision (or up sampling) scheme may be applied to up sample the triangles (and vertices) so that a smoother surface and visualization may be achieved. Then, displacements may be generated and represents 3D residuals between the input mesh and the subdivided mesh. At the decoder, the displacements and the base mesh may be decoded. The decoder may generate a subdivided mesh and generate a reconstructed mesh based on combining the displacements and the subdivided mesh. The encoder and the decoder may perform reciprocal subdivision of the base mesh such that the subdivided mesh does not need to be explicitly transmitted by the encoder to the decoder.

For example, the encoder may apply uniform subdivision to a base mesh (e.g., the reconstructed base mesh) to determine the subdivided mesh. Since the input mesh is unlikely to have uniform details, the displacements that are generated between the subdivided mesh and the input mesh may be large and results in increased coding bandwidth and rendering/reconstruction time at the decoder. For example, if the input mesh represents a person, portions of the input mesh such as those corresponding to the person's face, hands, and/or feet may have more detail and thus contain more triangles.

To improve upon existing subdivision schemes, input meshes may be adaptively coded with different resolutions such that the desired different LODs of the input mesh is not lost in the general compression process. In some examples, the regions (or sub-meshes) of the input mesh with different resolutions are detected and an adaptive sampling (or subdivision) process may be applied to a base mesh (or simplified mesh) to get closer to the input (e.g., original mesh). For example, the base mesh may be adaptively subdivided to generate the subdivided mesh such that certain portions (e.g., sub-meshes) of the base mesh are subdivided more than others. In some examples, the portions may be subdivided using one or more different parameter values and/or one or more different subdivision schemes. In some examples, the per-region parameters may be preconfigured or determined on the encoder side and are encoded in the bitstream and transmitted. By doing so, the displacements between the subdivided mesh and the input mesh may be reduced, which results in less displacement information that need to be encoded and transmitted. On the decoder side, after the bitstream is decoded, instead of applying a uniform level of sampling on the entire decoded base mesh, an adaptive sampling (subdivision) process, which is reciprocally performed by the encoder, is used to reconstruct the base mesh with different parameters per-region to get an estimation as close as its original resolution or the input mesh. In this way, the different LODs can be recreated by this adaptive step.

In some embodiments, whether adaptive subdivision (also referred to as adaptive mesh resolution) may be applied is based on an adaptive subdivision indication (or flag). For example, if adaptive subdivision is enabled, a per-region adaptive mesh subdivision may be applied. Different methods can be used to decide the region. For example, an octree can be used to decompose the space into a hierarchical structure and apply different levels of subdivision on the mesh in each region (or sub-mesh) adaptively. In contrast to uniform subdivision and/or applying a same set of parameters for a subdivision scheme (or algorithm), the adaptively subdivided mesh results in a better estimation of the original input mesh, which further results in a lower amount of displacement values. The regions associated with different subdivision parameters may be transmitted as additional metadata. In some examples, if enabled adaptive resolution, a decoder may decode a base mesh and apply, to the decoded base mesh, adaptive subdivision with additional metadata specifying where to adaptively subdivide at a per-region level. Then the subdivided mesh is deformed using the decoded displacements, the texture is then transferred from the base mesh onto the deformed mesh.

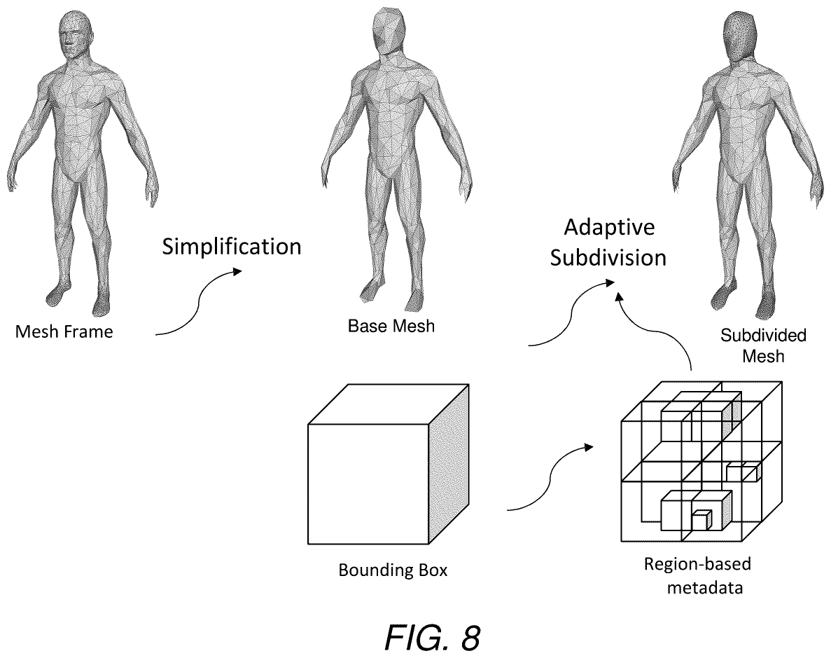

FIG. 8 illustrates an example of applying adaptive subdivision to a base mesh (e.g., a reconstructed base mesh) to generate a subdivided mesh, according to some embodiments.

As shown, the base mesh may be generated from an input mesh frame, as described above with respect to FIGS. 4-6 (e.g., as generated by mesh decimator 402 and/or mesh reconstruction process 410 of FIG. 4). The base mesh may simplify the mesh frame in the number of vertices, which also reduces the number of triangles. For example, the base mesh may include a subset of the vertices of the input mesh. Although the following descriptions are for triangle meshes, the described embodiments are also applicable to polygon meshes, according to some embodiments.

In some examples, a 3D bounding box illustrates the 3D boundaries of the input mesh may be computed. If a set of 3D mesh objects are intended to be encoded, then the maximum values representing the largest bounding box may be set as the global bounding box for the entire mesh sequence.

In some examples, the encoder (e.g., mesh subdivider 404 and/or mesh subdivider 418 of FIG. 4) may generate and use subdivision information to indicate how the base mesh is to be adaptively subdivided to generate a subdivided mesh. For example, subdivision information may include a data structure such as a tree data structure such as an octree, V3C Patch, a simple bounding box, KD tree, quadtree, binary tree, or other clustering-based data structures. The data structure indicates region-based metadata that specifies a level of detail for each region, which may be a sub-mesh of the base mesh. In some examples, the use of octrees may be advantageous to enable prediction techniques, such as intra prediction and inter prediction, across mesh frames of a mesh sequence. For purposes of illustration, the following descriptions refers to the use of the octree. In some embodiments, the data structure

For example, the octree may be applied to decompose the base mesh. The octree decomposition may be applied to the volume represented by the bounding box containing the base mesh. In existing technologies such as in point cloud coding technologies, an octree may decompose the 3D space until it reaches the last occupied voxel or reaching a preset threshold (e.g., iteration count). In some examples, octree decomposition may be repurposed to be iteratively applied to adaptively subdivide the base mesh to generate a subdivided mesh comprising portions (e.g., sub-meshes) that are subdivided to different levels (e.g., LODs).

In some embodiments, the octree decomposition may be iteratively applied to determine a plurality of adaptive subdivision parameters for the base mesh. After an iteration, each leaf node of the octree may correspond to a sub-volume containing a portion of the base mesh. In some examples, for each node (e.g., leaf node) of the octree, a determination as to whether to further subdivide the node (and corresponding sub-volume) may be based on a difference between the portion of the subdivided mesh, with the applied subdivision parameter associated with the node, and a portion of the input mesh corresponding to the portion of the subdivided mesh. For example, a second octree decomposition procedure may also be iteratively applied to the input mesh. In some examples, the determination may be based on a threshold or one or more cost criterion such as an error function or rate-distortion optimization (RDO) function. In some examples, a first number of triangles (or vertices) in the portion of the subdivided mesh (after performing subdivision) may be compared with a second number of triangles (or vertices) in the corresponding portion of the input mesh. For example, based on the difference being above a threshold, the sub-volume of the node may be further sub-divided into a plurality of sub-volumes corresponding to a plurality of child nodes. In some embodiments, the difference may be determined between a portion of the subdivided mesh with the applied subdivision parameter and an original surface corresponding to that portion of the input mesh. As explained above with respect to FIGS. 5-6, the difference may be determined as differences in displacements.

In some examples, the root node of the octree may represent the bounding box which contains the base mesh. For each iteration in the octree decomposition, each parent node will be decomposed into eight children node (e.g., for the first iteration, the root node is the parent node.) Each child node may store an explicit three-dimensional point which represents the “center” of the decomposition for that node and the sub-volume (or bounding box) size of that child node may be one-eighth of the one from its parent node.

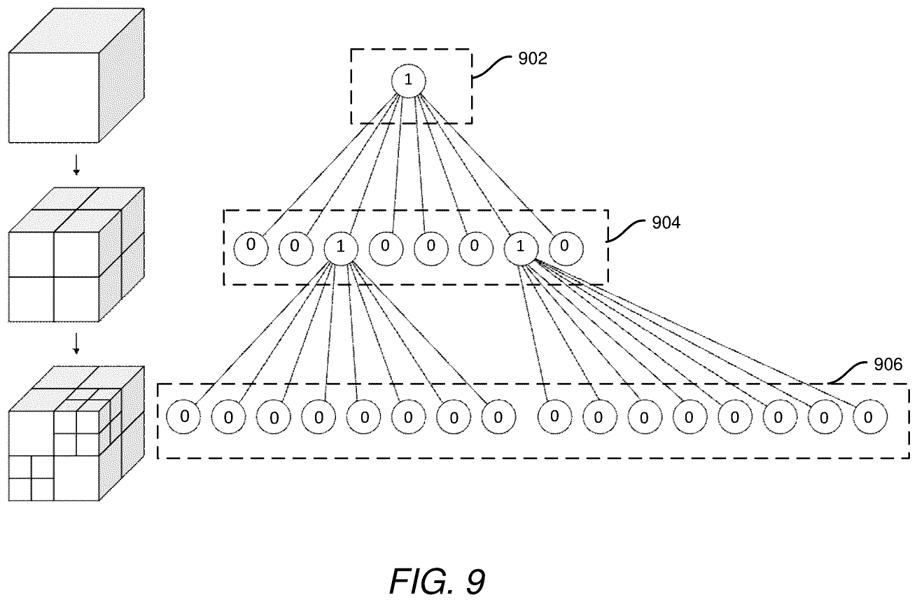

FIG. 9 illustrates an example of subdivision information, e.g., an octree, indicating adaptive subdivision of a base mesh, according to some embodiments. The base node of the octree may represent the volume (or bounding box) containing the base mesh (or reconstructed base mesh), as described in FIGS. 4-6. As shown as an example, the octree decomposition may result in three iterations 902, 904, and 906.

In some examples, for each iteration, for each node, a surface subdivider (e.g., mesh subdivider 404 and/or mesh subdivider 418 of FIG. 4) may determine one or more subdivision parameters and or whether to further subdivide for the node based on the triangles in a portion (corresponding to the node) of the subdivided mesh. For example, the determination may be based on an error function or rate distortion optimization (RDO) function. For example, for a node, it may be determined that a further octree decomposition is to be applied and one or more different subdivision parameters that may be applied to the children nodes.

In some embodiments, the threshold for determining a subdivision level (e.g., corresponding to a number of iterations of a subdivision scheme) may be based on a target number of vertices in the subdivided sub-mesh after subdividing the base sub-mesh; a target number of edges, formed by pairs of vertices, in the subdivided sub-mesh after subdividing the base sub-mesh; a target number of triangles, formed by triples of vertices, in the subdivided sub-mesh after subdividing the base sub-mesh; a target ratio or a fraction of vertices/triangles/edges in the subdivided sub-mesh compared to the base sub-mesh; or a combination thereof.

In some examples, after the adaptive subdivision function, an octree structure in the form of binary codes may be generated. The resulting octree structure illustrates the hierarchical adaptive subdivision parameters for each level of the octree and the corresponding triangles in the cuboids (or sub-cuboids or sub-volumes) represented by the octree leaf nodes.

In some embodiments, each node (of the octree or other tree data structure) may include or be associated with one or more adaptive subdivision parameters such as an resolution level (or another subdivision parameter) and/or a subdivision algorithm. As such, different leaves may have different subdivision algorithms applied and/or with different subdivision parameters such as a different resolution level. In some examples, leaf nodes at a lower level may correspond to more granular or higher density of vertices in the input mesh and may be associated with greater subdivision. Since each lower level (corresponding to higher iteration or number of subdivision) corresponds to a smaller cube (e.g., cuboid or sub-volume), the subdivision parameter may correspond to a size of the cube. In some examples, the subdivision parameter is the same for sub-volumes, of the volume, having the same size.

In some embodiments, the subdivision parameter indicates a subdivision scheme, from subdivision schemes, applied to subdivide the base sub-mesh. For example, the subdivision scheme may be one of two or more of: a mid-edge subdivision scheme, a butterfly subdivision scheme, a Doo-Sabin subdivision scheme, a loop subdivision scheme, a Catmull-Clark subdivision scheme, or a Kobbelt subdivision scheme.

In some examples, the octree may be represented as binary codes (e.g., as 1 00100010 0000000000000000 in the example of FIG. 9) where 1 represent a further decomposition is operated and a different subdivision parameter from the parent node is used in this current node and/or its children nodes. In some examples, the binary codes may be encoded by an arithmetic encoder, as will be further described below. In some examples, the binary codes may include a sequence of codes corresponding to a code for each iteration. For example, the binary code may include codes corresponding to iterations 902, 904, and 906 in sequence from the lowest level to the highest level where the level refers to a granularity/resolution/LOD.

In some examples, the octree structure (for adaptive subdivision) may be integrated with patch information, as used in the V3C specifications. For example, a patch may include one or more parameters indicating the octree is to be interpreted for adaptive subdivision.

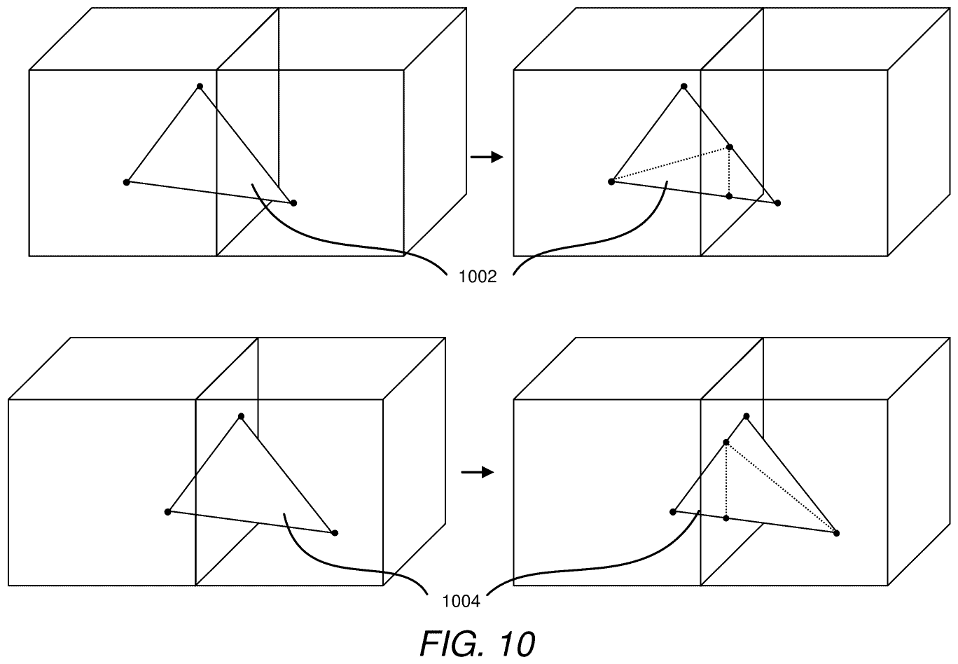

FIG. 10 illustrates an example for determining whether a triangle is in a cuboid (or a sub-volume), according to some embodiments. In some examples, if a triangle's three vertices are in the cube (including the ones exactly on the boundary), the triangle may be considered as being inside that cube and the subdivision parameters of that triangle may be associated with the cube. In some examples, if at least one vertex of that triangle is outside the cube, a decision need to be made to allocate the subdivision parameters to that triangle.

In some examples, octree decomposition may be used to determine an index order. For example, triangles of the base mesh may be marked as “not visited” in the initial stage and a triangle is marked as “visited” if the adaptive subdivision parameters are determined. If further octree decomposition iteration is determined to be applied, the triangles in that node (to be decomposed into eight children nodes) may be re-initialized as “not visited”.

In some examples, determination of allocating the subdivision parameters may be based on the surface areas of the triangle cut or separated by the intersected cube plane, as shown in FIG. 10. The cuboid (or sub-volumes) that contains a larger area of the triangle will result in that triangle being assigned or associated with the subdivision parameter of that cuboid. For example, based on the intersection of the triangles 1002 and 1004 based on a border between two neighboring cuboids, a left cuboid contains more of triangle 1002 and a right cuboid contains more of triangle 1004. Thus, a first subdivision parameter associated with the left cuboid will be applied to triangle 1002 and a second subdivision parameter associated with the right cuboid will be applied to triangle 1004.

In some embodiments, the determination of which subdivision parameter to apply to a triangle of the mesh (e.g., bash mesh) may be determined based on which cuboid a centroid of the triangle falls within.

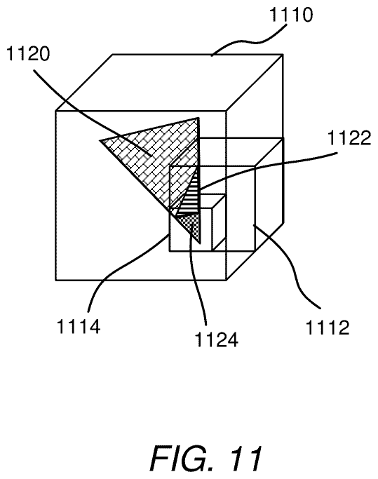

FIG. 11 illustrates an example of determining subdivision parameters adaptively, according to some embodiments. In some examples, using the triangles of the base mesh (within the cuboid) and the adaptively subdivided triangles of the subdivided mesh (within the cuboid corresponding to the child node), a 3D displacement may be computed. In some examples, the subdivision algorithm and subdivision parameters (e.g., a level) may be determined based on RDO or, e.g., selected to result in minimal displacement values.

For example, cube 1110 may be the volume representing the root node, cube 1112 is one of the children nodes of cube 1110, and cube 1114 is the child of cube 1112. The 3D object 1120 (shown as triangle in the figure) that is contained in the space or volume of cube 1110 can have a corresponding subdivision algorithm and level. Then, the cube 1110 may be decomposed into eight children nodes containing the volume (or space) that cube 1112 represents. The triangles 1122 that is contained in the volume (or space) of cube 1112 can then have a different subdivision algorithm and level and can be predicted from the parent node or neighboring nodes. Similarly, a subdivision algorithm and a level of subdivision, each of which may be the same or different, may be determined for triangles 1124 in the volume (or space) of cube 1114.

In some examples, at the decoder, after the simplified base mesh is decoded and the octree structure is decoded, the region-based signals may be extracted to adaptively subdivide the 3D base mesh into the subdivided mesh. Then, the displacements are applied onto subdivided mesh to deform the adaptively subdivided mesh to get as close as the input mesh.

In some examples, additional metadata such as attributes data associated with the triangle may be compressed and transmitted using, e.g., the V3C syntax and structure used in V-PCC.

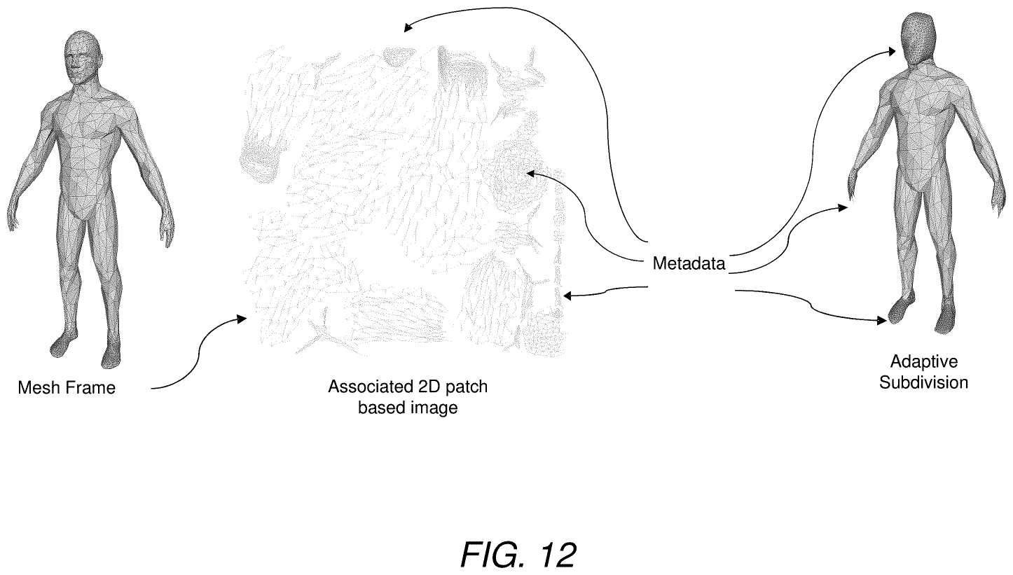

FIG. 12 illustrates an example of metadata to be transmitted for the input mesh (e.g., mesh frame), according to some embodiments. For example, the metadata may represent an associated 2D patch-based image that comprises attribute information of the base mesh frame (e.g., reconstructed base mesh). In some examples, the 2D patch-based image may be generated based on the subdivided mesh corresponding to the input mesh instead of the base mesh to provide smoother rendering at the decoder side. In some embodiments, to reduce displacement information and improved visual quality, the subdivided mesh may have been generated based on adaptive subdivision, as explained above with respect to FIGS. 8-12.

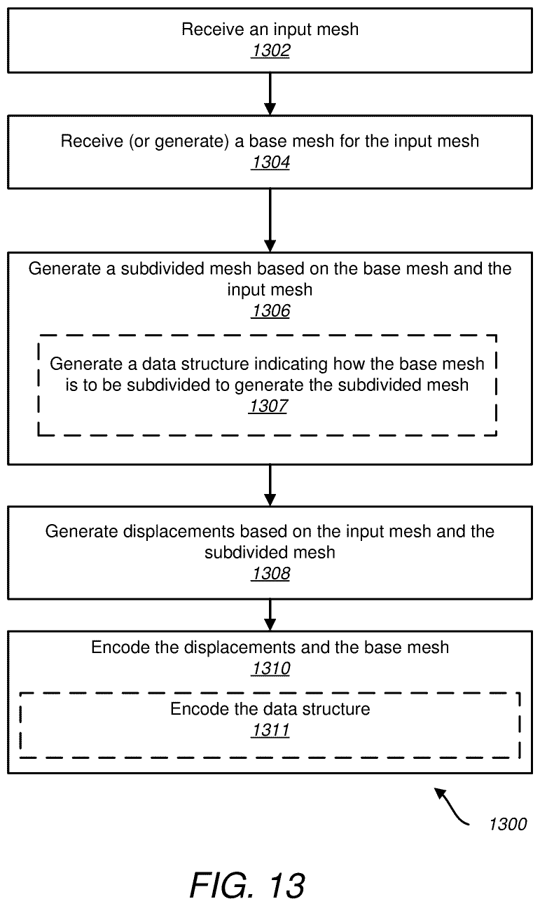

FIG. 13 illustrates a flowchart 1300 of an example method for encoding an input mesh (e.g., an input mesh frame or the reconstructed base mesh), according to some embodiments. The method of flowchart 1300 may be implemented by an encoder, such as encoder 200 in FIG. 2.

The method of flowchart 1300 begins at block 1302. At block 1302, the encoder receives an input mesh. For example, the input mesh may be a mesh frame of a sequence of mesh frames.

At block 1304, the encoder receives a base mesh for the input mesh. In some examples, the encoder generates the base mesh based on the input mesh. In some embodiments, the base mesh may refer to a reconstructed base mesh, as described above with respect to FIGS. 4-6.

At block 1306, the encoder generates a subdivided mesh based on the base mesh and the input mesh. For example, the subdivided mesh may correspond to the reconstructed base mesh being subdivided according to subdivision information.

In some examples, block 1306 may include block 1307. At block 1307, the encoder generates subdivision information including a data structure indicating how the base mesh is to be subdivided to generate the subdivided mesh. For example, the data structure may be a tree data structure such as an octree (or binary tree or quadtree, etc.).

In some examples, by generating the subdivided mesh based on both the base mesh and the input mesh, the base mesh may be adaptively subdivided. In other words, the base mesh is not uniformly subdivided. In some examples, the base mesh may be iteratively subdivided into sub-meshes and the iterative subdivision operations (e.g., represented by subdivision parameters) may be stored or updated in the data structure, as explained above with respect to FIGS. 8-9. In some examples, the encoder may apply a subdivision scheme with a subdivision parameter (e.g., a subdivision level or depth) to a sub-mesh. In some examples, by doing so, a plurality of sub-meshes may be subdivided using a plurality of different values for the subdivision parameter. In some examples, by doing so, a plurality of sub-meshes may be subdivided using a plurality of different subdivision schemes.

In some embodiments, one or more of the sub-meshes with the same subdivision parameters may be merged and stored and encoded in the data structure as part of one sub-mesh.

In some examples, a portion, of the data structure, that corresponds to a sub-mesh may further store the subdivision parameter and/or the subdivision scheme used by encoder to subdivide the sub-mesh.

In some embodiments, the subdivision scheme may be one of, e.g., a mid-edge, loop, butterfly, Doo-Sabin, Catmull-Clark, etc.

At block 1308, the encoder generates displacements based on the input mesh and the subdivided mesh. In some embodiments, the input mesh may correspond to a deformed mesh generated from the input mesh, as explained above with respect to FIG. 4. For example, the input mesh may be used to generate an initial base mesh that is subsequently subdivided and fitted to result in the deformed mesh (e.g., deformed mesh 436 of FIG. 4).

At block 1310, the encoder encodes the displacements (e.g., displacement information) and the base mesh. For example, the displacements may be encoded as described above with respect to FIGS. 2, 7, and 8.

In some examples, block 1310 may include block 1311, in which the encoder further encodes the data structure, as describe above with respect to FIGS. 8-9.

In some examples, the encoder may generate one or more indications/signals and/or parameters indicating adaptive subdivision was applied to generate the subdivided mesh. For example, a first indication may include whether adaptive subdivision is enabled/applied. For example, a first parameter may include a minimum subdivision level which may represent a minimum subdivision depth (or number of subdivision iterations) to be used to subdivide the base mesh. For example, a second parameter may include a subdivision increment which may represent, e.g., a number of subdivision iterations between each level of subdivision.

In some examples, the subdivided mesh may comprise a plurality of non-overlapping sub-meshes. In some examples, the one or more indications may be generated, encoded, and/or transmitted for each of the sub-meshes.

In some examples, the subdivided mesh may comprise one or more sub-meshes that overlap.

In some examples, the method of subdividing the base mesh, which is associated with a geometry of the input mesh, may be further applied to other attributes of the input mesh. For example, the adaptive subdivision may be similarly applied to texture, curvature, camera-distance, etc.

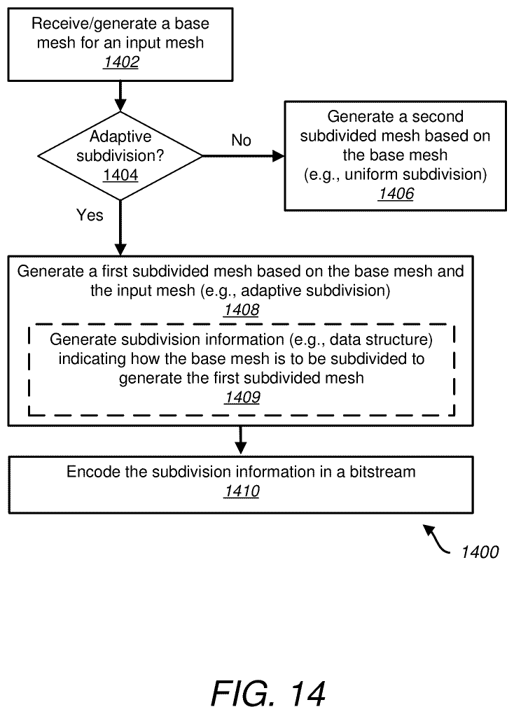

FIG. 14 illustrates a flowchart 1400 of an example method for encoding an input mesh, according to some embodiments. The method of flowchart 1400 may be implemented by an encoder, such as encoder 200 in FIG. 2.

The method of flowchart 1400 begins at block 1402. At block 1402, the encoder receives (or generates) a base mesh for an input mesh. For example, block 1402 may correspond to block 1302 and block 1304 of FIG. 13.

At block 1404, the encoder determines whether adaptive subdivision is enabled or to be applied. At block 1406, if adaptive subdivision is not enabled or applied, the encoder generates a second subdivided mesh based on the base mesh. For example, the encoder may (e.g., uniformly) apply a subdivision scheme with one or more subdivision parameters on the base mesh to generate the subdivided mesh. For example, the encoder may use the same values of the one or more subdivision parameters to generate the second subdivided mesh.

In some examples, the encoder may receive and decode an indication indicating whether adaptive subdivision is enabled (or applied). The encoder may determine whether adaptive subdivision is enabled based on the indication.

At block 1408, if adaptive subdivision is enabled or applied, the encoder generates a first subdivided mesh based on the base mesh and the input mesh (e.g., adaptive subdivision), as described above in block 1306 of FIG. 13. Block 1408 may include block 1409, in which the encoder generates subdivision information (e.g., a data structure such as an octree) indicating how the base mesh is to be subdivided to generate the first subdivided mesh, as described above in block 1307 of FIG. 13.

At block 1410, the encoder encodes the subdivision information (e.g., data structure) in a bitstream, as described above in block 1311 of FIG. 13. Further, the encoder may encode the base mesh and displacements, as described in FIG. 13.

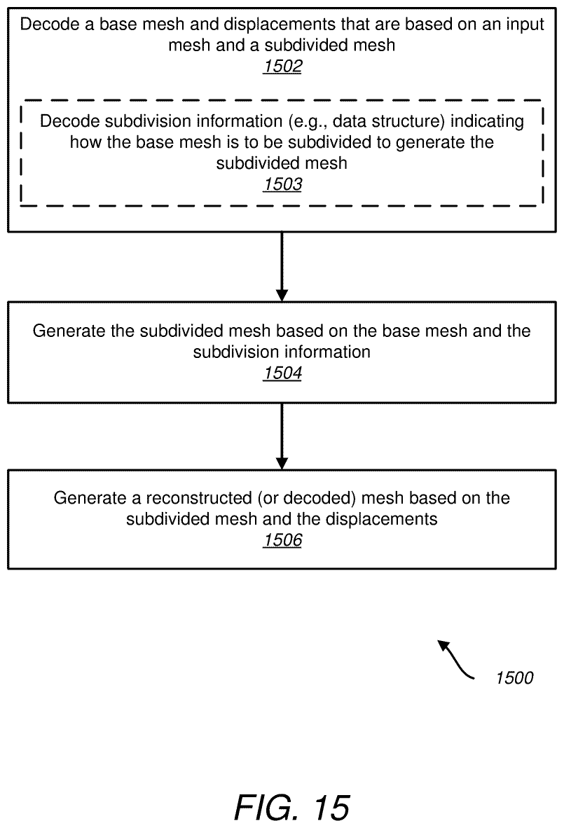

FIG. 15 illustrates a flowchart 1500 of an example method for decoding a mesh (also referred to as a mesh frame) to generate a reconstructed mesh corresponding to an input mesh, according to some embodiments. The method of flowchart 1500 may be implemented by an encoder, such as decoder 300 in FIG. 3.

The method of flowchart 1500 begins at block 1502. At block 1502, the decoder decodes a base mesh and displacements that are based on an input mesh and a subdivided mesh. For example, the base mesh and the displacements may be received from an encoder.

In some embodiments, the decoded base mesh corresponds to the reconstructed base mesh determined by an encoder such as at block 1304 of FIG. 13.

Block 1502 may include block 1503, in which the decoder decodes subdivision information (e.g., a data structure) indicating how the base mesh is to be subdivided to generate the subdivided mesh.

In some examples, the subdivision information includes a data structure such as a tree data structure (e.g., an octree, a quad tree, etc.) that corresponds to a volume of the base mesh. In some examples, each leaf node of the data structure indicates a subdivision level applied to a sub-volume, of the volume, corresponding to the leaf node. The sub-volume may include a sub-mesh of the base mesh.

At block 1504, the decoder generates the subdivided mesh based on the base mesh and the subdivision information. In some examples, the volume (of the base mesh) may be iteratively split into sub-volumes based on the data structure. For example, each node of an octree may indicate whether a sub-volume corresponding to that node is to be further subdivided into a plurality of second sub-volumes (e.g., 8 for octrees). In some examples, for each leaf node of the data structure, the decoder applies a subdivision scheme, with a subdivision parameter (e.g., a subdivision level) indicated by the leaf node, to subdivide triangles of the portion of the base mesh contained in the sub-volume corresponding to the leaf node. For example, the subdivision scheme may subdivided the vertices, edges, and/or faces of the sub-mesh contained in the sub-volume.

At block 1506, the decoder generates a reconstructed mesh based on the subdivided mesh and the displacements. The reconstructed mesh may correspond to the input mesh received at the encoder. For example, the reconstructed mesh may correspond to a reconstruction of the input mesh at the encoder.

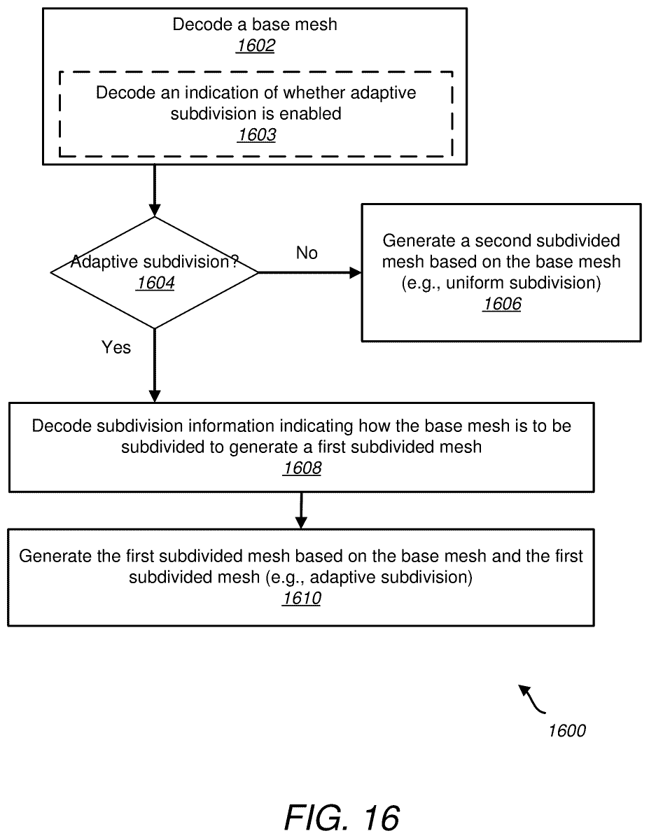

FIG. 16 illustrates a flowchart 1600 of an example method for decoding an input mesh, according to some embodiments. The method of flowchart 1600 may be implemented by a decoder, such as decoder 300 of FIG. 3.

The method of flowchart 1600 begins at block 1602. At block 1602, the decoder decodes a base mesh. For example, block 1602 may correspond to block 1502 of FIG. 15. Block 1602 may include block 1603, in which the decoder decodes an indication of whether adaptive subdivision is enabled or applied.

At block 1604, the decoder determines whether adaptive subdivision is enabled or applied, e.g., based on the indication. At block 1606, based on the adaptive subdivision not being enabled (or being disabled), the decoder generates a second subdivided mesh based on the base mesh. For example, the decoder may perform uniform subdivision, as described above.

At block 1608, based on the adaptive subdivision being enabled, the decoder decodes, from the bitstream, subdivision information (e.g., a data structure such as an octree data structure) indicating how the base mesh is to be subdivided to generate a first subdivided mesh.

At block 1610, the decoder generates the first subdivided mesh based on the base mesh and the first subdivided mesh.

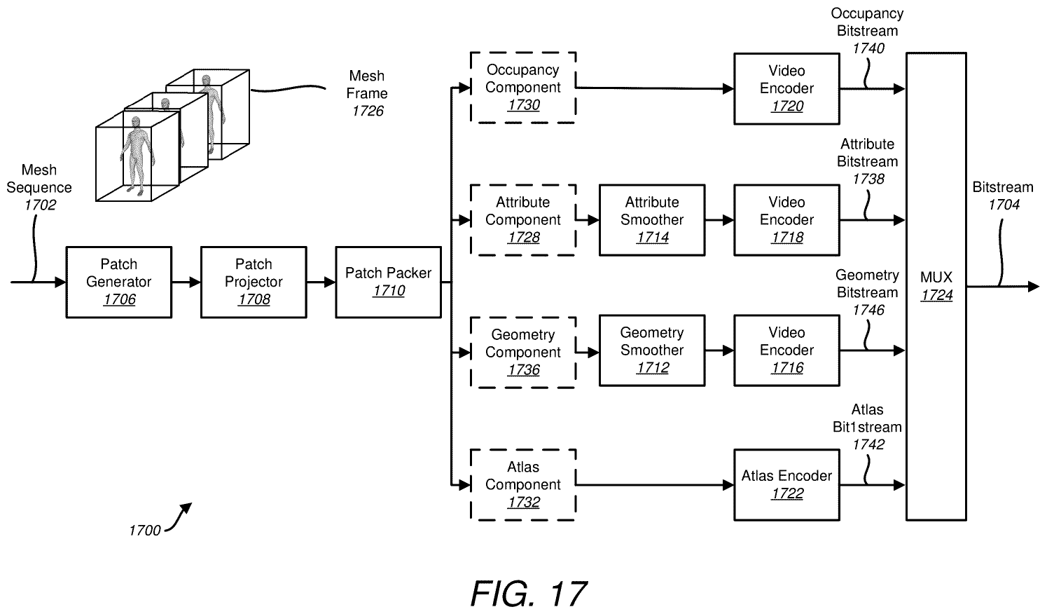

FIG. 17 illustrates an example encoder 1700 for encoding attributes information of a mesh frame, according to some embodiments. Encoder 1700 encodes a mesh sequence 1702 into a bitstream 1704 for more efficient storage and/or transmission. Encoder 1700 may be implemented in mesh coding/decoding system 100 in FIG. 1, such as within encoder 114, or in any one of a number of different devices, including a cloud computer, a server, a desktop computer, a laptop computer, a tablet computer, a smart phone, a wearable device, a television, a camera, a video gaming console, a set-top box, a video streaming device, an autonomous vehicle, or a head mounted display. Encoder 1700 comprises a patch generator 1706, a patch projector 1708, and patch packer 1710, a geometry smoother 1712, an attribute smoother 1714, video encoders 1716, 1718, and 1720, an atlas encoder 1722, and a multiplexer (mux) 1724. In some examples, encoder 1700 may be used to encode attribute information of a mesh frame such as one of mesh frames 124. For example, the texture encoder and/or material encoder (and/or metadata encoder) of encoder 114 may be implemented based on one or more components of encoder 1700 of FIG. 17. In some embodiments, encoder 1700 may be combined with encoder 200A-B of FIGS. 2A-2B for encoding the 3D geometry of mesh frames. For example, encoder 1700 may be used to encode attributes information of mesh frames whereas encoder 200A-B may encode 3D geometry information of the mesh frames.

Encoder 1700 may convert one or more mesh frames of mesh sequence 1702 (e.g., mesh frames 124 of FIG. 1) from 3D to 2D and then apply one or more 2D video encoders or encoding methods to the 2D images. For example, encoder 1700 may convert a mesh frame 1726 of mesh sequence 1702 from 3D to 2D by projecting mesh frame 1726 in different projection directions onto 2D projection surfaces. The different projections may then be packed together to produce multiple 2D images referred to as 2D image components. The 2D image components may include a geometry component 1736, one or more optional attribute component(s) 1728, and an occupancy component 1730.

To reduce projection issues, such as self-occlusion and hidden surfaces, patch generator 1706 may first segment mesh frame 1726 into a number of regions referred to as 3D patches before encoder 1700 performs projections onto 2D projection surfaces. Patch generator 1706 may begin the segmentation process by first estimating the normal vector to the surface of one or more points in mesh frame 1726 using any one of a number of different normal vector estimation algorithms. Each of the one or more points may then be associated with one of multiple different projection directions. For example, each of the one or more points may be associated with one of the six orthographic projection directions +/−X, +/−Y, and +/−Z. In another example, each of the one or more points may be associated with one of a group of projection directions comprising the six orthographic projections and one or more of the 12 different 45-degree projection directions. A point may be initially associated with one of multiple different projection directions based on which projection direction the normal vector of the point is most closely aligned with (e.g., as determined by the projection direction that results in the largest dot product with the normal vector of the point). Patch generator 1706 may update the initial projection direction associated with a point based on the associated projection directions of its neighboring points. After finalizing the projection direction associated with each of the one or more points, patch generator 1706 may apply a connected component algorithm to create groups of points with the same associated projection directions. Each of these groups may be used to form a 3D patch. It should be noted that the above description provides only one example method for determining and/or generating 3D patches and is not meant to be limiting. Patch generator 1706 may use other methods for determining and/or generating 3D patches.

After determining and/or generating the 3D patches, patch projector 1708 may project each 3D patch onto a 2D projection surface in the projection direction associated with the points of the 3D patch.

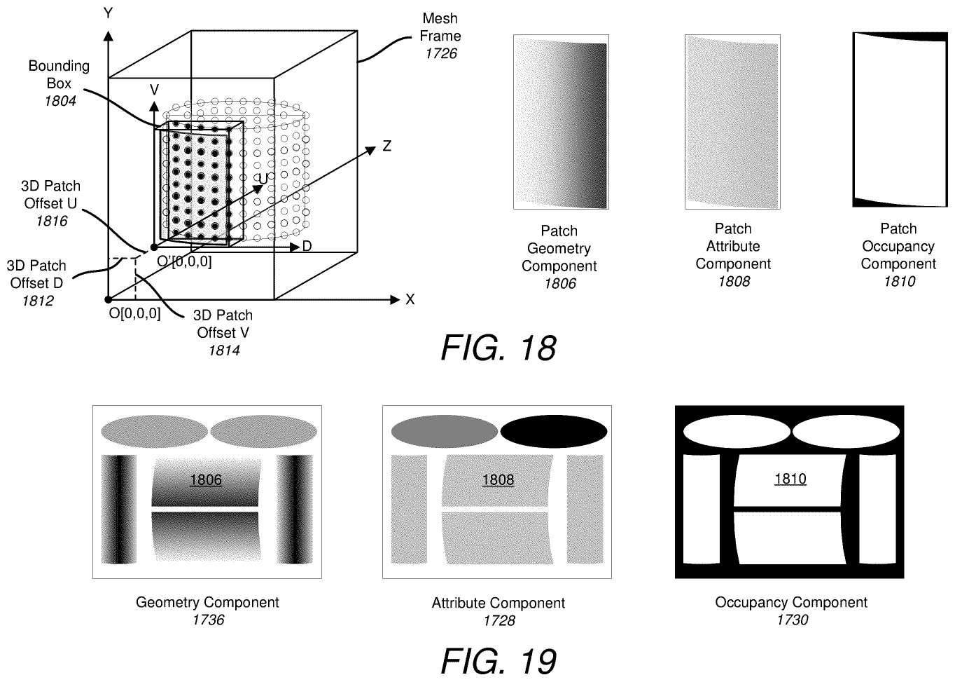

FIG. 18 illustrates an example patch projection that may be performed by patch projector 1708, according to some embodiments. In FIG. 18, a 3D patch is determined and/or generated for mesh frame 1726 in FIG. 17. For example, the 3D patch may be determined and/or generated by patch generator 1706 in accordance with the segmentation process discussed above. The 3D patch comprises a group of points, from mesh frame 1726, that are shown as black dots in FIG. 18. Other points in mesh frame 1726 that are not part of the 3D patch are shown as unfilled circles in FIG. 18. These other points in mesh frame 1726 may be segmented into one or more other 3D patches not shown in FIG. 18 for case of illustration.

After being determined and/or generated, patch projector 1708 may project the 3D patch onto one of the six faces of an axis aligned bounding box 1804 that encompasses the 3D patch or onto one or more other surfaces not shown in FIG. 18. Bounding box 1804 comprises axes D, V, and U that are respectively aligned with the X, Y, and Z axes of mesh frame 1726. The face of axis aligned bounding box 1804 that the 3D patch is projected may be determined based on the projection direction associated with the points of the 3D patch. In the example of FIG. 18, the 3D patch is projected in the −Z direction or, equivalently, the −U direction onto the forward oriented face of axis aligned bounding box 1804 shown in FIG. 18. The projection of the 3D patch results in multiple 2D patch components, including a patch geometry component 1806, a patch attribute component 1808, and a patch occupancy component 1810.

Patch geometry component 1806 may indicate the respective 3D position of points in the 3D patch. For example, a point located at Cartesian coordinate (x, y, z) in the 3D patch may be orthographically projected onto the forward oriented face of axis aligned bound box 1804. Because the 2D projection surface lies on one of the six faces of axis-aligned bounding box 1804, two of the three coordinates of the point will remain the same after projection other than some potential offset due to the positioning of bounding box 1804. For example, because a point of the 3D patch in FIG. 18 is orthographically projected in the −Z direction or, equivalently, the −U direction, the point's (x, y) coordinates will remain the same after projection other than the x coordinate of the point being offset by 3D patch offset D 1812 and the y coordinate of the point being offset by 3D patch offset V 1814. The point's z-coordinate may then be stored as an intensity value (e.g., one of a luminance, chrominance, or RGB color component value) of the pixel at position (x, y) in the 2D projection. Alternatively, the distance between the point and the 2D projection surface may be stored as an intensity value (e.g., one of a luminance, chrominance, or RGB color component value) of the pixel at position (x, y) in the 2D projection, and the 3D patch offset U 1816 may be stored elsewhere to allow for recovery of the point's z coordinate. Because patch geometry component 1806 stores depth information using intensity values of the pixels, patch geometry component 1806 resembles a depth map as shown in FIG. 18, with darker colors representing points closer to the 2D projection surface and lighter colors representing points farther away from the 2D projection surface.

Patch attribute component 1808 may be used to indicate optional attribute information of the points in the 3D patch. For example, a point in the 3D patch projected to a given pixel in 2D patch geometry component 1808 may correspond to (and project to) the same pixel in patch attribute component 1808. However, the corresponding pixel in patch attribute component 1808 may be used to store attribute information of the point in the 3D patch rather than distance information. For example, one or more intensity values of the pixel in patch attribute component 1808 may be used to store texture (e.g., color) of the point, a material type of the point, transparency information of the point, reflectance information of the point, a normal vector to a surface of the point, a velocity at the point, an acceleration at the point, a time stamp indicating when the point was captured, or a modality indicating when the point was captured (e.g., running, walking, or flying). A different patch attribute component may be used for each different type of attribute information indicated by a point in the 3D patch. For example, one patch attribute component may be used to store color information of the points in the 3D patch, while another patch attribute component may be used to store transparency information. In another example, patch attribute component 1808 may be used to store multiple different types of attribute information indicated by points in the 3D patch.

Patch occupancy component 1810 may indicate which samples in patch geometry component 1806 and patch attribute component 1808 are associated with data in the 3D patch. For example, patch occupancy component 1810 may be a binary image as shown in FIG. 18 that indicates whether a pixel in one or more of the other 2D patch components corresponds to a valid 3D projected point from mesh frame 1726. A binary image is an image that comprises pixels with two colors, such as black and white as shown in FIG. 18. Each pixel of a binary image may be stored using a single bit, with “0” representing one of the two colors and “1” representing the other of two colors. In the example of FIG. 18, the color black in patch geometry component 1810 indicates samples in patch geometry component 1806 and patch attribute component 1808 that are not associated with data in the 3D patch. The color white in patch geometry component 1810 indicates samples in patch geometry component 1806 and patch attribute component 1808 that are associated with data in the 3D patch.

It should be noted that a 3D patch may have multiple points that project onto a same pixel location. In such an instance, patch projector 1708 may use several 2D image components to store the information of the overlapping points. For example, patch projector 1708 may use a near 2D image component and a far 2D image component. The near 2D image component may be used to store the information of an overlapping point that is closest to a projection surface (or that has the lowest depth value). The far 2D image component may be used to store the information of an overlapping point that is farthest from a projection surface (or that has the highest depth value). Encoder 1700 may place the near and far 2D image components into separate video streams or temporally interleave them into a single stream. The near or far 2D image component may be coded as a differential component from the other 2D image component. Alternatively, the one of the two 2D image components may be dropped and an interpolation scheme may be used to recover the information of the dropped 2D image component.

Referring back to FIG. 17, patch packer 1710 may pack the different 2D patch components generated for each 3D patch of mesh frame 1726 into the respective 2D image components. For example, and as shown in FIG. 19, patch packer 1710 may pack: 2D patch geometry components generated for 3D patches of mesh frame 1726 into 2D geometry component 1736, 2D patch attribute components (e.g., for a single attribute type) generated for the 3D patches of mesh frame 1726 into 2D attribute component 1728, and 2D patch occupancy components generated for the 3D patches of mesh frame 1726 into 2D occupancy component 1730. Patch components 1806, 1808, and 1810 from FIG. 18 are shown in FIG. 19 as being packed into the 2D image components 1736, 1728, and 1730, respectively.

Patch packer 1710 may pack 2D patch components in 2D image components of size W pixels wide and H pixels high (W×H) by first ordering the 2D patch components by size and then placing each 2D patch component in a 2D image component, e.g., in order of largest to smallest size, at a first location in raster scan order that guarantees insertion of the 2D patch component without overlapping previously inserted 2D patch components. If there are no valid insertion positions for a 2D patch component in the 2D image component due to overlap, patch packer 1710 may increase the size of the 2D image component. For example, patch packer 1710 may increase one or both of the width and height of the 2D image component. For example, patch packer 1710 may double one or both of the width and height of the 2D image component. Patch packer 1710 may increase the chances of finding a valid insertion position for a 2D patch component in a 2D image component by rotating and/or mirroring a 2D patch component. For example, patch packer 1710 may use one or more of eight different 2D patch component orientations based on four possible rotations combined with or without mirroring. In another example, patch packer 1710 may pack 2D patch components to have similar positions as 2D patch components in other frames (across time) that share similar content. For example, patch packer 1710 may determine 2D patch components of different frames that “match” according to some matching algorithm and place the matching 2D patch components at the same or similar positions within their respective 2D image components. This packing method may improve compression efficiency.

Encoder 1700 may further provide information to a decoder for reconstructing a 3D mesh from 2D image components, like 2D image components 1728, 1730, and 1736. Encoder 1700 may provide this information in an additional component referred to as an atlas component. For each patch in the 2D image components of a mesh frame, encoder 1700 may include information in the atlas component for determining one or more of:
the 2D bounding box that contains the 2D component of the patch in each of the 2D image components;
the orientation of the 2D component of the patch in each of the 2D image components;
the location of the 3D bounding box, in the 3D mesh frame, that contains the 3D patch; and
the projection plane of the patch.

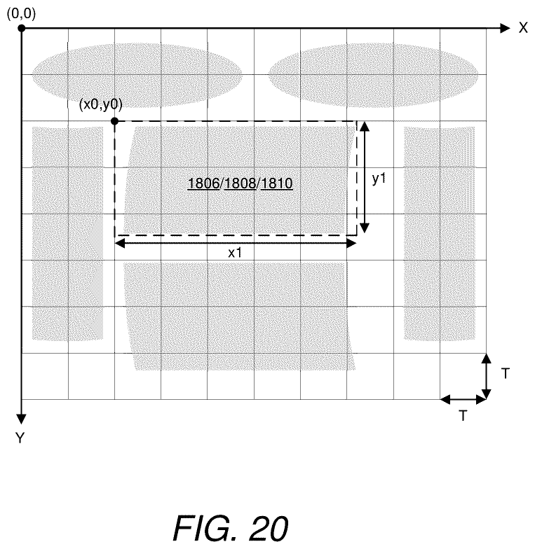

For example, for the patch with patch components—including patch geometry component 1806, patch attribute component 1808, and patch occupancy component 1810 shown in FIG. 18—encoder 1700 may include in an atlas component 1732 information for determining the 2D bounding box that contains patch components 1806, 1808, and 1810 in 2D image components 1736, 1728, and 1730, respectively. For example, as shown in FIG. 20, encoder 1700 may include in atlas component 1732 the coordinate (x0, y0) of the upper left most point of the 2D bounding box of patch components 1806, 1808, and 1810 and the length x1 and width y1 of the 2D bounding box. Using these pieces of information, a decoder may determine the 2D bounding box in 2D image components 1736, 1728, and 1730 that contains patch components 1806, 1808, and 1810.

In addition, encoder 1700 may include information in atlas component 1732 for the patch with patch components 1806, 1808, and 1810 indicating how the patch was reoriented (if at all) by patch packer 1710 prior to being packed in 2D image components 1730, 1728, and 1736. For example, encoder 1700 may include a patch orientation index in atlas component 1732 for the patch that indicates any rotation or mirroring of the patch performed by patch packer 1710 before being packed in 2D image components 1730, 1728, and 1736. For example, patch packer 1710 may reorient patch components 1806, 1808, and 1810 by rotating them 90 degrees to the right before packing them in 2D image components 1730, 1728, and 1736. Encoder 1700 may include an appropriate patch orientation index for the patch of patch components 1806, 1808, and 1810 that indicates this 90 degree rotation to the right.

Encoder 1700 may include information in atlas component 1732 for the patch with patch components 1806, 1808, and 1810 indicating the location of 3D bounding box 1804 that contains the 3D patch in 3D mesh frame 1726. For example, encoder 1700 may include in atlas component 1732 3D patch offset D 1812, 3D patch offset V 1814, and 3D patch offset U 1816 shown in FIG. 18.

Encoder 1700 may include information in atlas component 1732 for the patch with patch components 1806, 1808, and 1810 indicating the projection plane of the patch. For example, as shown in FIG. 18, the projection plane of the patch with patch components 1806, 1808, and 1810 is the projection plane in the −U direction. Encoder 1700 may include in atlas component 1732 an index indicating this projection plane.

During packing of 2D patch components in 2D image components, patch packer 1710 may map the 2D patch components onto a 2D grid of blocks overlaying the 2D image components. Patch packer 1710 may map the 2D patch components onto the 2D grid of blocks such that each block of the 2D grid is occupied by a single 2D patch component. FIG. 20 further illustrates an example 2D grid overlaying the 2D image components of FIG. 19. The blocks of the 2D grid are of size T×T, where T may be measured in terms of pixels (e.g., 4, 8, or 16 pixels). As shown in FIG. 20, the 2D patch components are mapped to the 2D image components of FIG. 19 such that each block of the 2D grid is occupied by a single 2D patch component. Although patch packer 1710 may pack the 2D patch components such that each block of the 2D grid is occupied by a single 2D patch component, patch packer 1710 may pack the 2D patch components in the 2D image components such that the bounding boxes of the 2D patch components overlap. In such an instance, a T×T block in an overlapping area may be determined to belong to the last placed 2D patch component in the 2D image components. The placement order of 2D patch components may be determined based on their respective patch indexes, which may indicate placement order (e.g., later placed patch components may have higher associated patch indexes) and be further included in an atlas component for a patch. Encoder 1700 may include the block size T in an atlas component. For geometry components, patch packer 1710 may further fill empty space between patches using a padding function. For example, patch packer 1710 may fill empty T×T blocks of a geometry component by copying either the last row or column of the previous T×T block in raster scan order. Patch packer 1710 may fill partially empty T×T blocks (i.e., blocks with both valid and non-valid pixels) with the average value of non-empty neighboring pixels.

Referring back to FIG. 17, to reduce possible artifacts caused, for example, by the segmentation of mesh frame 1726 into patches by patch generator 1706, geometry smoother 1712 may smooth the points at the boundary of patches in geometry component 1736. For example, geometry smoother 1712 may identify points at patch edges in geometry component 1736 and apply a smoothing filter to the points. Attribute smoother 1714 may similarly perform smoothing of points at the boundary of patches in attribute component 1728.

Video encoders 1716, 1718, and 1720 respectively encode geometry component 1736, attribute component 1728, and occupancy component 1730. In the example of encoder 1700, separate video encoders 1716-1720 are used to respectively encode geometry component 1736, attribute component 1728, and occupancy component 1730. In other embodiments, a single video encoder may be used to encode all or multiple ones of geometry component 1736, attribute component 1728, and occupancy component 1730. Video encoders 1716, 1718, and 1720 may encode geometry component 1736, attribute component 1728, and occupancy component 1730 according to a video or image codec, such as AVC, HEVC, VVC, VP8, VP9, AV1 or the like. Video encoders 1716, 1718, and 1720 may respectively provide a geometry bitstream 1746, an attribute bitstream 1738, and an occupancy bitstream 1740 as output. Each bitstream 1738-1746 may include respective encoded components for each mesh frame of mesh sequence 1702.

Video encoders 1716, 1718, and 1720 may apply spatial prediction (e.g., intra-frame or intra prediction), temporal prediction (e.g., inter-frame prediction or inter prediction), inter-layer prediction, and/or other prediction techniques to reduce redundant information in a sequence of one or more 2D image components, such as a sequence of geometry components, attribute components, or occupancy components. Before applying the one or more prediction techniques, video encoders 1716, 1718, and 1720 may partition the 2D image components into rectangular regions referred to as blocks. Video encoders 1716, 1718, and 1720 may then encode a block using one or more of the prediction techniques.

For temporal prediction, video encoders 1716, 1718, and 1720 may search for a block similar to the block being encoded in another 2D image component (also referred to as a reference picture) of a sequence of 2D image components. The block determined during the search (also referred to as a prediction block) may then be used to predict the block being encoded. For spatial prediction, video encoders 1716, 1718, and 1720 may form a prediction block based on data from reconstructed neighboring samples of the block to be encoded within the same 2D image component of the sequence of 2D image components. A reconstructed sample refers to a sample that was encoded and then decoded. Video encoders 1716, 1718, and 1720 may determine a prediction error (also referred to as a residual) based on the difference between a block being encoded and a prediction block. The prediction error may represent non-redundant information that may be transmitted to a decoder for accurate decoding of a sequence of 2D image components.

Video encoders 1716, 1718, and 1720 may apply a transform to the prediction error (e.g., a discrete cosine transform (DCT)) to generate transform coefficients. Video encoders 1716, 1718, and 1720 may provide as output the transform coefficients and other information used to determine prediction blocks (e.g., prediction types, motion vectors, and prediction modes). In some examples, video encoders 1716, 1718, and 1720 may perform one or more of quantization and entropy coding of the transform coefficients and/or the other information used to determine prediction blocks to further reduce the number of bits needed to store and/or transmit a sequence of 2D image components.

Atlas encoder 1722 may compress atlas component 1732. As discussed above, atlas component 1732 includes information for reconstructing a 3D mesh frame from 2D image components. For example, for one or more patches in 2D image components 1728, 1730, and 1736, atlas component 1732 may include information indicating: the 2D bounding box that contains the 2D component of the patch in each of the 2D image components; the orientation of the 2D component of the patch in each of the 2D image components; the location of the 3D bounding box, in the 3D mesh frame, that contains the 3D patch; and the projection plane of the patch. Atlas encoder 1722 may compress atlas component 1732 using a prediction technique. For example, atlas encoder 1722 may predict information in atlas component 1732 using the information in other atlas components and remove redundant information between the two components. Atlas encoder 1722 may further perform entropy encoding of atlas component 1732. Atlas encoder 1722 may provide an atlas bitstream 1742 output. Atlas bitstream 1742 may include an encoded atlas component for each mesh frame of mesh sequence 1702.

Mux 1724 may multiplex the different bitstreams 1738-1746 from video encoders 1716, 1718, and 1720 and atlas encoder 1722 to form bitstream 1704. Bitstream 1704 may be sent to a decoder for decoding. In some examples, bitstream 1704 may be part of the same bitstream as bitstream 266 of FIGS. 2A-B.

It should be noted that encoder 1700 is presented by way of example and not limitation. In other examples, encoder 1700 may have other components and/or arrangements. For example, one or more of the components shown in FIG. 17 may be optionally included in encoder 1700, such as geometry smoother 1712 and attribute smoother 1714.

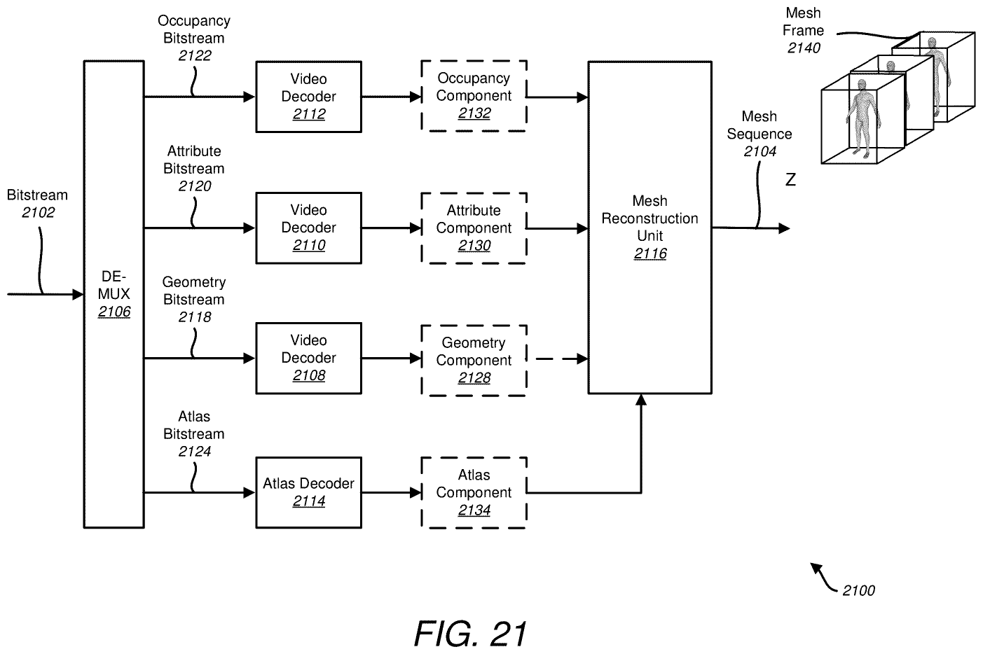

FIG. 21 illustrates an example decoder 2100 in which embodiments of the present disclosure may be implemented. Decoder 2100 decodes a bitstream 2102 into a decoded mesh sequence 2104 for display and/or some other form of consumption. Decoder 2100 may be implemented in mesh coding/decoding system 100 of FIG. 1 or in any one of a number of different devices, including a cloud computer, a server, a desktop computer, a laptop computer, a tablet computer, a smart phone, a wearable device, a television, a camera, a video gaming console, a set-top box, a video streaming device, an autonomous vehicle, or a head mounted display. Decoder 2100 comprises a de-multiplexer (de-mux) 2106, video decoders 2108, 2110, and 2112, an atlas decoder 2114, and a mesh reconstruction unit 2116.

De-mux 2106 may receive bitstream 2102 and de-multiplex bitstream 2102 into different bitstreams, including a geometry bitstream 2118, an optional attribute bitstream 2120, an occupancy bitstream 2122, and an atlas bitstream 2124. Geometry bitstream 2118 may comprise a geometry component for each mesh frame of mesh sequence 2104. For example, geometry bitstream 2118 may include a geometry component 2128 for mesh frame 2140 of mesh sequence 2104. Attribute bitstream 2120 may include an attribute component for each mesh frame of mesh sequence 2104. For example, attribute bitstream 2120 may include an attribute component 2130 for mesh frame 2140 of mesh sequence 2104. Occupancy bitstream 2122 may include an occupancy component for each mesh frame of mesh sequence 2104. For example, occupancy bitstream 2122 may include an occupancy component 2132 for mesh frame 2140 of mesh sequence 2104. Finally, atlas bitstream 2124 may include an atlas component for each mesh frame of mesh sequence 2104. For example, atlas bitstream 2124 may include an atlas component 2134 for mesh frame 2140 of mesh sequence 2104.

The components included in bitstreams 2118-2124 may be in compressed form. For example, the components of geometry bitstream 2118, attribute bitstream 2120, and occupancy bitstream 2122 may have been compressed according to a video or image codec, such as AVC, HEVC, VVC, VP8, VP9, Av1, or the like. Video decoders 2108, 2110, and 2112 may respectively decode the components of geometry bitstream 2118, attribute bitstream 2120, and occupancy bitstream 2122. In other embodiments, a single video decoder may be used to decode all or multiple ones of geometry bitstream 2118, attribute bitstream 2120, and occupancy bitstream 2122. Atlas decoder 2114 may decode the components of atlas bitstream 2124.

After the components of the different bitstreams 2118-2124 are decoded, a respective component from each bitstream 2118-2124 may be provided to mesh reconstruction unit 2116 for a mesh frame of mesh sequence 2104. For example, for mesh frame 2140 of mesh sequence 2104, mesh reconstruction unit 2116 may receive geometry component 2128, attribute component 2130, occupancy component 2132, and atlas component 2134. Mesh reconstruction unit 2116 may use the information in atlas component 2134 to reconstruct mesh frame 2140 from geometry component 2128, attribute component 2130, and occupancy component 2132. For example, atlas component 2134 may include, for each of one or more patches, information indicating: the 2D bounding box that contains the 2D component of the patch in each of components 2128-2132; the orientation of the 2D component of the patch in each of components 2128-2132; the location of the 3D bounding box, in the 3D mesh frame, that contains the 3D patch; and the projection plane of the patch. Using this information and potentially other information included in atlas component 2134, mesh reconstruction unit 2116 may extract 2D patches from each of components 2128-2132, reconstruct the points of the patch in 3D space, and associate attribute information (e.g., texture information) to each point of the patch. The reconstructed mesh frames of the mesh may be output by mesh reconstruction unit 2116 as mesh sequence 2104.

It should be noted that decoder 1800 is presented by way of example and not limitation. In other examples, decoder 1800 may have other components and/or arrangements.

In some embodiments, decoder 1800 may be combined with decoder 300 of FIG. 3 such that decoder 1800 may decode attributes information associated with mesh frame 1640 and decoder 300 may decode geometry of mesh frame 1640. For example, according to some embodiments, video decoder 2108 and geometry component 2128 may be replaced with the components of decoder 300 of FIG. 3.

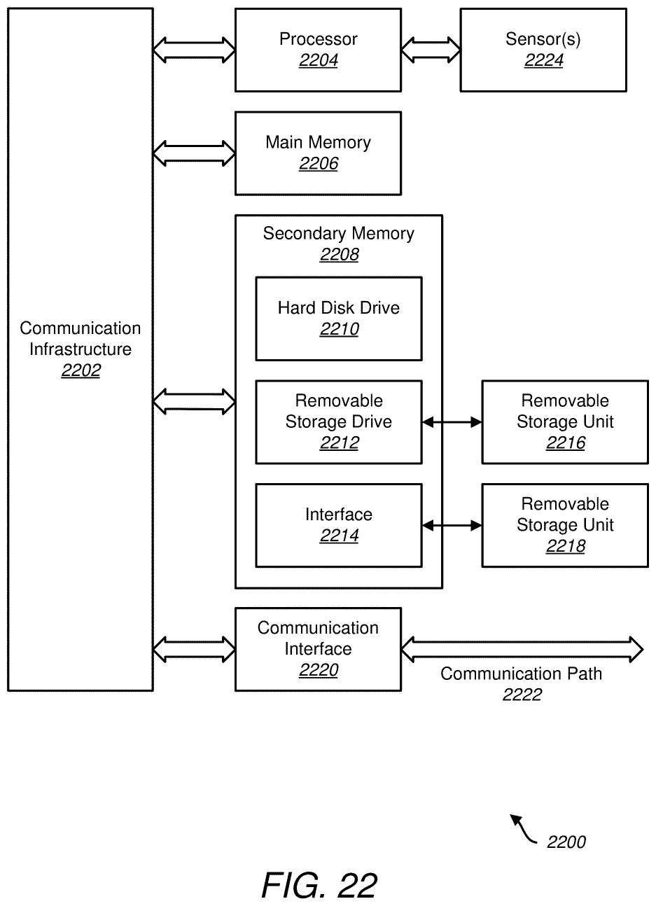

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2200 is shown in FIG. 22. Blocks depicted in the figures above, such as the blocks in FIGS. 1, 2A-B, 3, 4, 17, and 21, may execute on one or more computer systems 2200. Furthermore, each of the steps of the flowcharts depicted in this disclosure may be implemented on one or more computer systems 2200. When more than one computer system 2200 is used to implement embodiments of the present disclosure, the computer systems 2200 may be interconnected by one or more networks to form a cluster of computer systems that may act as a single pool of seamless resources. The interconnected computer systems 2200 may form a “cloud” of computers.

Computer system 2200 includes one or more processors, such as processor 2204. Processor 2204 may be, for example, a special purpose processor, general purpose processor, microprocessor, or digital signal processor. Processor 2204 may be connected to a communication infrastructure 2202 (for example, a bus or network). Computer system 2200 may also include a main memory 2206, such as random access memory (RAM), and may also include a secondary memory 2208.

Secondary memory 2208 may include, for example, a hard disk drive 2210 and/or a removable storage drive 2212, representing a magnetic tape drive, an optical disk drive, or the like. Removable storage drive 2212 may read from and/or write to a removable storage unit 2216 in a well-known manner. Removable storage unit 2216 represents a magnetic tape, optical disk, or the like, which is read by and written to by removable storage drive 2212. As will be appreciated by persons skilled in the relevant art(s), removable storage unit 2216 includes a computer usable storage medium having stored therein computer software and/or data.

In alternative implementations, secondary memory 2208 may include other similar means for allowing computer programs or other instructions to be loaded into computer system 2200. Such means may include, for example, a removable storage unit 2218 and an interface 2214. Examples of such means may include a program cartridge and cartridge interface (such as that found in video game devices), a removable memory chip (such as an EPROM or PROM) and associated socket, a thumb drive and USB port, and other removable storage units 2218 and interfaces 2214 which allow software and data to be transferred from removable storage unit 2218 to computer system 2200.

Computer system 2200 may also include a communications interface 2220. Communications interface 2220 allows software and data to be transferred between computer system 2200 and external devices. Examples of communications interface 2220 may include a modem, a network interface (such as an Ethernet card), a communications port, etc. Software and data transferred via communications interface 2220 are in the form of signals which may be electronic, electromagnetic, optical, or other signals capable of being received by communications interface 2220. These signals are provided to communications interface 2220 via a communications path 2222. Communications path 2222 carries signals and may be implemented using wire or cable, fiber optics, a phone line, a cellular phone link, an RF link, and other communications channels.

Computer system 2200 may also include one or more sensor(s) 2224. Sensor(s) 2224 may measure or detect one or more physical quantities and convert the measured or detected physical quantities into an electrical signal in digital and/or analog form. For example, sensor(s) 2224 may include an eye tracking sensor to track the eye movement of a user. Based on the eye movement of a user, a display of a mesh may be updated. In another example, sensor(s) 2224 may include a head tracking sensor to the track the head movement of a user. Based on the head movement of a user, a display of a mesh may be updated. In yet another example, sensor(s) 2224 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a mesh.

As used herein, the terms “computer program medium” and “computer readable medium” are used to refer to tangible storage media, such as removable storage units 2216 and 2218 or a hard disk installed in hard disk drive 2210. These computer program products are means for providing software to computer system 2200. Computer programs (also called computer control logic) may be stored in main memory 2206 and/or secondary memory 2208. Computer programs may also be received via communications interface 2220. Such computer programs, when executed, enable the computer system 2200 to implement the present disclosure as discussed herein. In particular, the computer programs, when executed, enable processor 2204 to implement the processes of the present disclosure, such as any of the methods described herein. Accordingly, such computer programs represent controllers of the computer system 2200.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
receiving, from a bitstream, subdivision information indicating sub-volumes of a volume containing a base mesh of a mesh, wherein each sub-volume of the sub-volumes indicates a respective base sub-mesh of base sub-meshes together forming the base mesh;
subdividing the base mesh according to the subdivision information, wherein each base sub-mesh of the base sub-meshes is subdivided based on a subdivision parameter corresponding to the sub-volume indicating the base sub-mesh; and
generating the mesh based on the subdivided base mesh.

2. The method of claim 1, wherein the subdivision parameter indicates:
a subdivision level of a subdivision scheme; or
a number of iterations of the subdivision scheme.

3. The method of claim 1, wherein the subdivision parameter further indicates the subdivision scheme as one of a plurality of subdivision schemes.

4. The method of claim 1, wherein the subdivision information indicates the volume being partitioned into non-overlapping sub-volumes, and wherein the sub-volumes are determined based on the non-overlapping sub-volumes.

5. The method of claim 1, further comprising:
decoding, from the bitstream, information indicating vertices and triangles of the base mesh.

6. The method of claim 1, wherein the generating the mesh comprises:
determining, from the bitstream, displacements for vertices of the subdivided base mesh, and wherein the mesh is generated based on applying the displacements to the vertices of the subdivided base mesh.

7. The method of claim 6, wherein the displacements comprise a displacement vector for each vertex of the vertices of the subdivided base mesh, and wherein applying the displacements comprises adding the displacement vector to a respective vertex of the vertices.

8. The method of claim 6, wherein the determining the displacements comprises:
decoding, from the bitstream, wavelet coefficients representing the displacements;
performing inverse quantization of the wavelet coefficients; and
performing inverse wavelet transform of the inverse-quantized wavelet coefficients to determine the displacements.

9. A decoder comprising:
one or more processors; and
memory storing instructions that, when executed by the one or more processors, cause the decoder to:
receive, from a bitstream, subdivision information indicating sub-volumes of a volume containing a base mesh of a mesh, wherein each sub-volume of the sub-volumes indicates a respective base sub-mesh of base sub-meshes together forming the base mesh;
subdivide the base mesh according to the subdivision information, wherein each base sub-mesh of the base sub-meshes is subdivided based on a subdivision parameter corresponding to the sub-volume indicating the base sub-mesh; and
generate the mesh based on the subdivided base mesh.

10. The decoder of claim 9, wherein the subdivision parameter indicates:
a subdivision level of a subdivision scheme; or
a number of iterations of the subdivision scheme.

11. The decoder of claim 9, wherein the subdivision parameter further indicates the subdivision scheme as one of a plurality of subdivision schemes.

12. The decoder of claim 9, wherein the subdivision information indicates the volume being partitioned into non-overlapping sub-volumes, and wherein the sub-volumes are determined based on the non-overlapping sub-volumes.

13. The decoder of claim 9, wherein the decoder is further caused to:
decode, from the bitstream, information indicating vertices and triangles of the base mesh.

14. The decoder of claim 9, wherein the generation of the mesh comprises:
determining, from the bitstream, displacements for vertices of the subdivided base mesh, and wherein the mesh is generated based on applying the displacements to the vertices of the subdivided base mesh.

15. The decoder of claim 14, wherein the displacements comprise a displacement vector for each vertex of the vertices of the subdivided base mesh, and wherein applying the displacements comprises adding the displacement vector to a respective vertex of the vertices.

16. The decoder of claim 14, wherein the determining the displacements comprises:
decoding, from the bitstream, wavelet coefficients representing the displacements;
performing inverse quantization of the wavelet coefficients; and
performing inverse wavelet transform of the inverse-quantized wavelet coefficients to determine the displacements.

17. A non-transitory computer-readable medium comprising instructions that, when executed by one or more processors, cause the one or more processors to:
receive, from a bitstream, subdivision information indicating sub-volumes of a volume containing a base mesh of a mesh, wherein each sub-volume of the sub-volumes indicates a respective base sub-mesh of base sub-meshes together forming the base mesh;
subdivide the base mesh according to the subdivision information, wherein each base sub-mesh of the base sub-meshes is subdivided based on a subdivision parameter corresponding to the sub-volume indicating the base sub-mesh; and
generate the mesh based on the subdivided base mesh.

18. The non-transitory computer-readable medium of claim 17, wherein the subdivision parameter indicates:
a subdivision level of a subdivision scheme; or
a number of iterations of the subdivision scheme.

19. The non-transitory computer-readable medium of claim 17, wherein the subdivision parameter further indicates the subdivision scheme as one of a plurality of subdivision schemes.

20. The non-transitory computer-readable medium of claim 17, wherein the generation of the mesh comprises:
determining, from the bitstream, displacements for vertices of the subdivided base mesh, and wherein the mesh is generated based on applying the displacements to the vertices of the subdivided base mesh.
